(19) United States
(12) Patent Application Publication
(10) Pub. No.: US 2008/0134911 A1
(43) Pub. Date: Jun. 12, 2008

(54) Embossing Device With Embossing Roller Composed Of An Interchangeable Sleeve And Supporting Centers

(75) Inventors: Mauro Gelli, Lucca (IT); Romano Maddaleni, Pisa (IT); Fabio Giachetti, Pisa (IT)

Correspondence Address: BREINER & BREINER, L.L.C., P.O. BOX 320160, ALEXANDRIA, VA, 22320-0160, US

(73) Assignee: Fabio Perini S.p.A., Lucca (IT)

(21) Appl. No.: 11/792,627

(22) PCT Filed: Dec. 7, 2005
(86) PCT No.: PCT/IT05/00721

§ 371 Date: Jul. 9, 2007

(30) Foreign Application Priority Data
Dec. 10, 2004 (IT) FI2004A000258

(51) Int. Cl. B31F 1/07

(52) U.S. Cl. 101/23

(57) ABSTRACT

The embossing device comprises at least one embossing roller (3) and at least one counter-roller (5) cooperating with said embossing roller. The embossing roller comprises an interchangeable sleeve (19) which can be constrained to two heads (13, 15) which engage the sleeve at the ends thereof.

### TECHNICAL FIELD

The present invention relates in general to devices for the continuous processing of a web material, such as and in particular, although not exclusively, paper, especially tissue paper.

More specifically, the present invention relates to an embossing device, i.e. a device comprising at least one embossing roller and at least one counter-roller (for example a pressure roller coated in rubber or another yielding material) positioned with parallel axes and cooperating with each other, in the sense that the embossing roller and the pressure roller are pressed against each other to form an embossing nip therebetween.

### STATE OF THE ART

Embossing is a mechanical process which is performed on materials in sheet form, i.e. web form, typically paper and especially tissue paper, to modify the characteristics of softness and absorption capacity, as well as to increase the apparent thickness and decorate the web material.

This process consists in feeding one or more plies of paper between an embossing roller made of a hard material such as steel or the like, provided with protuberances, and a counter-roller. The two rollers are positioned with axes parallel to each other and are placed adjacent to, or pressing against, each other. The counter-roller can have a machined surface with a series of depressions complementary to the protuberances of the roller, but it will more frequently be a pressure roller with a smooth and yielding surface, which is pressed against the embossing roller, so that the protuberances of the latter penetrate the yielding coating of the pressure roller to deform the paper or other material in sheet form which is fed between the two counter rotating rollers.

In the tissue paper converting industry the embossing unit is typically used to emboss tissue paper for producing rolls of toilet paper, kitchen towels or the like, or for producing paper handkerchiefs and napkins.

In these applications modification of the embossing pattern, that is, the arrangement of the protuberances on the embossing roller may be required, both for technical and for aesthetic requirements.

This entails replacing the embossing roller or rollers of the embossing unit with other rollers. The operation to replace the rollers can be extremely complex and lengthy, as these are mechanical members of considerable weight and size. Moreover, these rollers have a significant cost and consequently the need to have a certain number of embossing rollers to produce different embossing patterns implies high costs.

Consequently, various systems have been studied to produce embossing rollers with an interchangeable sleeve, on which the embossing pattern is produced, which sleeve is assembled on a central supporting core. In this way it is sufficient to have a plurality of interchangeable sleeves rather than a plurality of complete rollers in order to change the embossing pattern. Replacement is simplified and the interchangeable sleeves cost less than the entire roller.

Examples of embossing devices or units with interchangeable sleeve and of systems to fasten the sleeves on the core of the embossing roller are described in U.S. Pat. No. 6,716,017; WO-A-03/045679; WO-A-03/045680; U.S. Pat. No. 4,003,114; EP-A-0836928.

### OBJECTS AND SUMMARY OF THE INVENTION

The object of the present invention is to produce a new type of embossing roller with interchangeable sleeve.

A further object of a particularly advantageous embodiment of the invention is to produce a roller with interchangeable sleeve wherein assembly of the sleeve is particularly simple.

Yet another object of the invention is to produce a roller with interchangeable sleeve in which a space is not required at the side of the mass of the structure of the embosser, but instead the sleeve to be replaced is removed and the new sleeve is assembled within the space delimited by the sides of the embosser.

One or more of the aforesaid objects are obtained in substance with an embossing device in which the embossing roller comprises an interchangeable sleeve, which can be constrained to two heads, which engage the sleeve at the ends thereof. According to the invention, therefore, instead of a sleeve which is fitted on a core with conical surface and fastened thereon with various possible fastening means, the roller is in this case composed only of the sleeve and of the respective engaging heads which cooperate with the ends of said sleeve.

One of the two heads and preferably both the heads have expansion means, such as expansible sectors to engage the sleeve torsionally with the head or heads.

Advantageously, according to a possible embodiment, one of the two heads is supported idle and the other is motorized. Preferably, at least the latter is advantageously provided with expansible means, such as expansible sectors or the like, for fastening and reciprocal torsional engagement between head and sleeve.

According to a possible embodiment of the invention, the head assembled idle is advantageously provided with an axial movement to engage with the sleeve or to disengage therefrom. This axial movement therefore allows the sleeve to be fastened on the heads or centers or to be disengaged in order to be replaced with another sleeve with a different embossing pattern, or with a different arrangement of protuberances on the cylindrical surface thereof. It would also be possible to provide both heads or centers with an axial movement to engage with the ends of the sleeve and to disengage therefrom. Two motorized heads or centers could also be used, rather than a single motorized head, should greater power be required. Moreover, only one head could be motorized and said motorized head could also be provided with the axial movement, although the solution of separating motorization from axial movement results in a simpler configuration.

In an advantageous embodiment of the invention the heads or centers to engage the sleeve have conical surfaces cooperating with corresponding concave conical surfaces produced at the level of the end portions of the sleeve and which are engaged by said heads. The conical surfaces allow correct reciprocal centering between the engaging heads or centers and the sleeve. The centering surfaces can also have forms differing from a simple conical surface, although this conical surface is preferred.

The motorized head or center, or optionally both heads or centers can be provided with a shaped profile for torsional coupling, for example a splined profile or a simple slot and tongue arrangement to supply further torsional coupling between sleeve and center or head. This is particularly indicated in the case of embossing rollers of large diameter, which require high torsional moments.

Further advantageous characteristics and embodiments of the device according to the invention are indicated in the appended claims and will be further described hereunder with reference to a non-limiting example of embodiment.

### BRIEF DESCRIPTION OF THE DRAWINGS

The invention will be better understood following the description and accompanying drawing, which shows a non-limiting and exemplifying embodiment of the invention. More specifically, in the drawing:

FIG. 1 shows a schematic side view of an embossing unit according to the invention;

FIG. 2 shows a front view, with sectional parts of the embossing unit in FIG. 1;

FIG. 3 shows an enlarged longitudinal section of the idle center and of the system for support and axial movement;

FIG. 4 shows an enlargement of the motorized center;

FIG. 5 shows a front view of the center in FIG. 4; and

FIG. 6 shows a schematic side view of an embodiment of the invention in a more complex embossing device.

### DETAILED DESCRIPTION OF A PREFERRED EMBODIMENT OF THE INVENTION

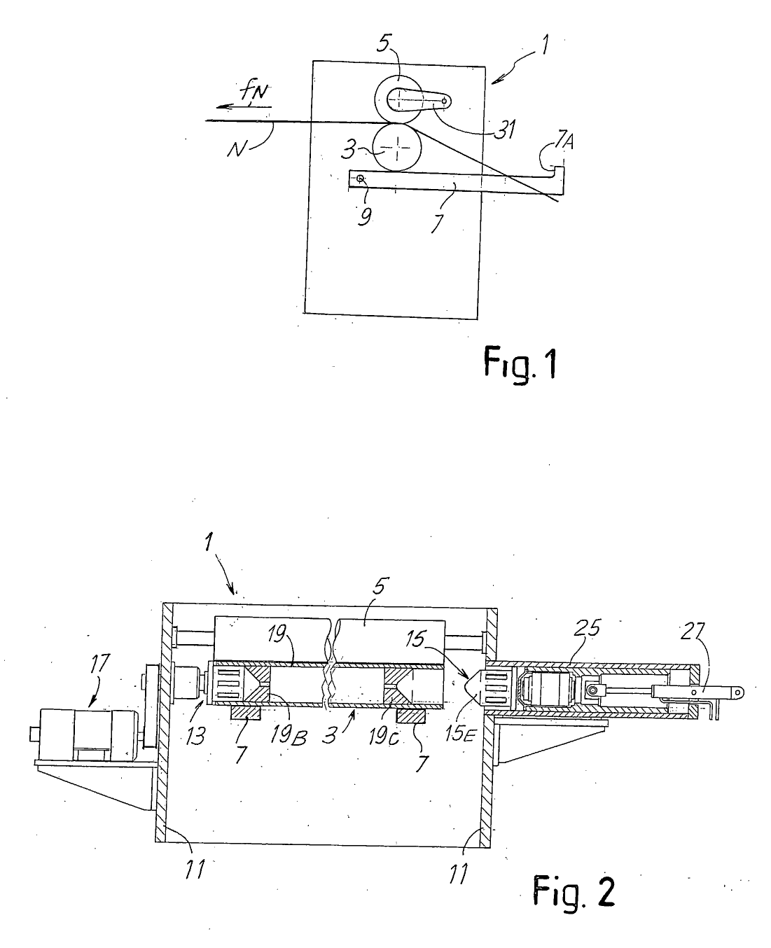

FIG. 1 shows very schematically a side view of an embossing device according to the invention.

The device, generically indicated with 1, has an embossing roller 3, which in the example is arranged below the path of the web material N to be embossed, and a pressure roller or counter-roller 5, which advantageously has a smooth surface, rigid or yielding. The web material N (for example tissue paper with one, two or more plies) is fed along its feed path according to the arrow fN and through the nip between the rollers 3 and 5 to be embossed. Downstream of the embossing nip formed by the rollers 3 and 5 the embossed web material N is fed to a further converting machine, such as a machine to produce napkins, rolls or the like.

Arranged under the embossing roller 3 is a chute 7, optionally hinged in 9 to perform a downward oscillating movement according to the arrow F. The chute 7 has an end stop 7A. The purpose of the chute 7 is to receive an interchangeable sleeve, which forms the active surface in the embossing roller 3 and to allow it to roll until reaching the stop 7A, or to receive a new sleeve with which to replace the one previously operating. The chute 7 can also be in a fixed position and consequently does not oscillate according to the arrow F.

FIG. 2 shows the members of the embossing device 1 in greater detail in a front and partially sectional view. The sides of the device are indicated with 11. The pressure roller 5, and two expansible centers or heads, indicated generically and as a whole with 13 and 15, are supported on these sides in a per se known way. The expansible head 13 is motorized by a motor 17. Preferably it is not provided with an axial movement, but only with a movement of rotation about its own axis, imparted by the motor 17.

As can be seen in greater detail in FIGS. 4 and 5, the expansible head 13 has a stop flange 13A which can cooperate with an end edge of an interchangeable sleeve 19 which forms, once engaged with the heads or centers 13, 15, and together therewith, the embossing roller 3. The outer cylindrical surface of the sleeve 19 has raised embossing areas or protuberances which, by pressing against the surface of the pressure roller 5 above, emboss the web material N. If the roller 5 is provided (as is usually the case) with a yielding surface, the protuberances of the interchangeable sleeve 19 partially penetrate the yielding surface of the pressure roller 5 and the web material between the rollers 3 and 5 is consequently permanently deformed.

The flange 13A is succeeded by a substantially cylindrical portion 13B of the center 13, inside which are expansible sectors 13C controlled with a member of a per se known type, not shown, to be extracted from the cylindrical portion of the portion 13B, or retracted therein. Extraction of the expansible sectors 13C causes torsional engagement between the center 13 and the interchangeable sleeve 19, the sectors 13C acting on the inner cylindrical surface of the end of the sleeve 19 into which the center 13 is inserted, as can be seen in detail in FIG. 4.

The portion 13B of the head 13 can also have a shaping, such as a slot, indicated with 13D in FIG. 5, which cooperates with a tongue or a boss produced on the inner cylindrical surface of the end cavity of the sleeve 19. The interlock thus obtained between tongue and slot guarantees transmission of the torsional moment between the center or head 13, driven by the motor 17, and the sleeve 19. Alternatively, several slots and several tongues, or even a splined profile, can be provided to obtain interlock. Interlock can be omitted when friction between the expansible sectors 13C and the inner cylindrical surface of the sleeve 19 is sufficient to transmit the torsional moment required for rotation of the roller 3.

Finally, the head 13 has an end portion 13E with a conical shape, which cooperates with a corresponding conical surface 19A provided on a block 19B fixed inside the interchangeable sleeve 19 and delimiting the end cavity of said sleeve into which the head 13 is inserted.

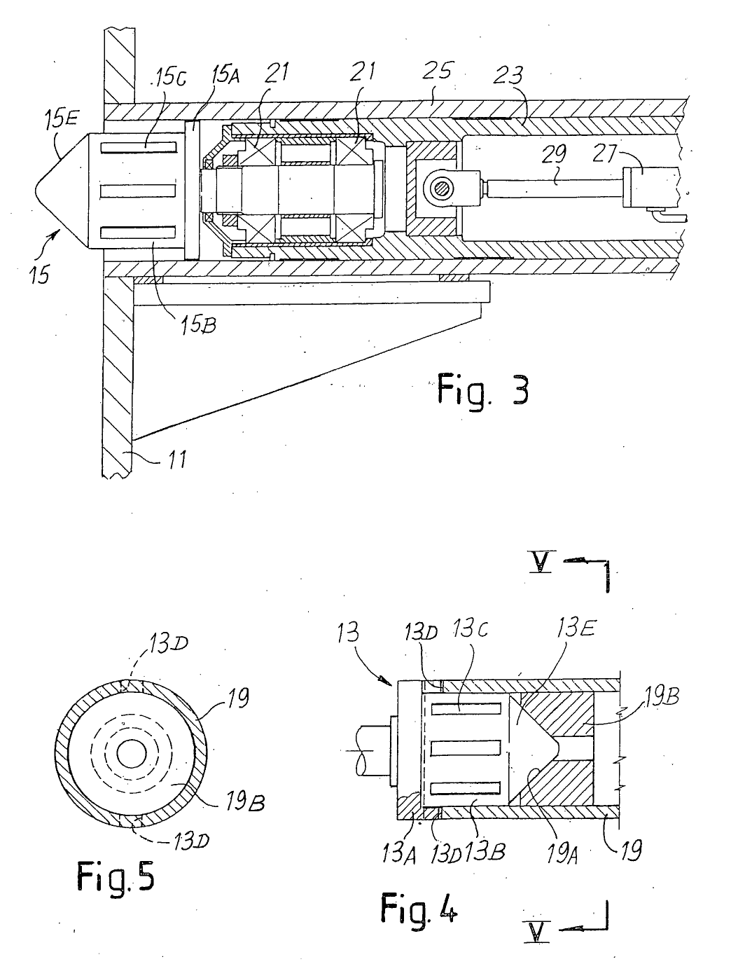

The head or center 15 has a configuration substantially identical to the head 13 with regard to the flange, the cylindrical portion with the expansible sectors and the conical portion. These elements are indicated in FIGS. 2 and 3 with the reference number 15 followed by the letter corresponding to the one used for the same elements represented in FIG. 4 for the head 13.

The head 15 cooperates by means of the conical surface 15E thereof with a block 19C, equivalent to the block 19B, which delimits the end cavity of the interchangeable sleeve 19 into which the expansible head or center 15 is inserted. The expansible head 15, contrary to the head 13, is not motorized, but supported idle as shown in greater detail in FIG. 3.

As can be seen in FIG. 3, the expansible head or center 15 is supported by means of an arrangement of bearings 21 inside a lining 23 sliding in a tube 25 supported by the side 11. Constrained to tube 25 is the cylinder of a piston-cylinder actuator 27, the rod 29 of which is constrained to the lining 23. With this arrangement the head or center 15 can be moved axially between two end positions represented with a broken line and with a solid line in FIG. 2. In the position represented with a broken line the head 15 is engaged (analogously to the head 13) in the corresponding end cavity of the sleeve 19. In this position the interchangeable sleeve 19 and the centers or heads 13, 15 fastened to the sleeve, form the embossing roller 3. In the position represented by the solid line in FIG. 2 the head or center 15 is disengaged from the interchangeable sleeve 19 and the latter—with an axial movement, from left to right in the drawing—can be disengaged from the head 13 and then made to roll on the chute 7 to be removed. Having removed the interchangeable sleeve 19, this can be replaced with another interchangeable sleeve 19 which has, on the outer surface thereof, a different embossing pattern, i.e. a different distribution of the embossing protuberances. The new interchangeable sleeve 19 is fastened on the centers or heads 13, 15 with the opposite operation to the one described above. In the example in FIG. 1, to perform these operations it is sufficient to make the interchangeable sleeve 19 roll on the chute 7 towards the stop 7A, place a new sleeve 19 on said chute 7, for example by lowering it from above, make it roll in the opposite direction and take it to the operating position against the roller 5, where it will again be engaged by the centers or heads 13, 15 to be made to rotate.

The centers or heads 13, 15 also guarantee reliable axial positioning of the sleeve 19, thanks to the conical surfaces 13E, 15E cooperating with the corresponding conical surfaces 19A of the interchangeable sleeve 19. The expansible sectors provided on at least one and preferably on both of the heads 13, 15, guarantee torsional coupling between the centers and the sleeve, while the tongue and slot profile, or an equivalent grooved profile optionally provided on at least the motorized center or head 13, guarantees the transmission of even extremely high torsional moments.

In a modified embodiment the expansible sectors 13C, 15C, which normally operate on the inner cylindrical surface of the corresponding end cavity of the interchangeable sleeve 19, can also be configured to function as grooved profiles, and in this case they will be inserted in corresponding slots parallel to the axis of the interchangeable sleeve 19 produced on the inner cylindrical surface of the end cavity of the sleeve. This solution is, however, critical with regard to the tolerances, as particularly precise machining of the slots inside the interchangeable sleeves and of the expansible sectors of the centers or heads is required.

To facilitate removal of the interchangeable sleeve 19, the pressure roller 5 can advantageously be supported by oscillating arms 31 (FIG. 1), which are associated with pressure actuators which press the cylinder or roller 5 with the roller 3 and which optionally raise the arm 31 during replacement of the sleeve 19 to facilitate removal thereof.

From the above it can be seen that movement of the interchangeable sleeve takes place along a path contained between the sides 11 of the device 1 and therefore within the volume in width of said device. This results in clear advantages in the layout of the line in which the embosser is inserted.

The same inventive concept described above with reference to a simple embosser, comprising a single embossing roller composed of an interchangeable sleeve and relative end heads or centers, cooperating with a pressure roller, can be extended to produce more complex embossing units.

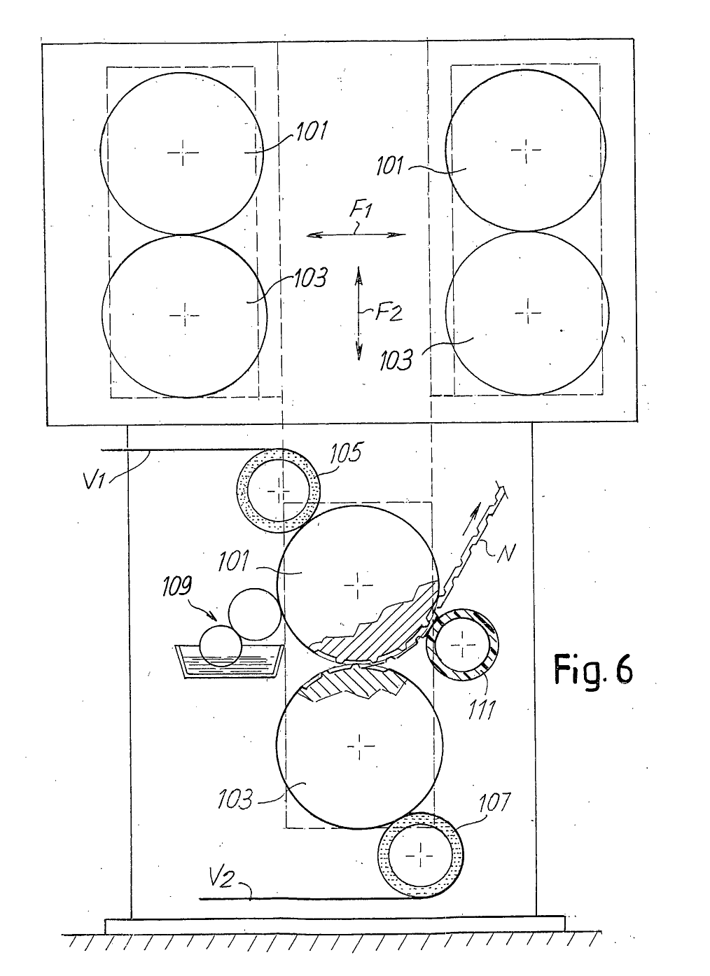

FIG. 6 shows a schematic side view of a double embosser comprising a first embossing roller 101, a second embossing roller 103, a first counter-roller 105 and a second counter-roller 107. A glue dispenser 109 and a laminating roller 111 are also provided.

The cylindrical surfaces of the rollers 101, 103 are equipped with protuberances and the rollers 101, 103 are reciprocally phased so that the protuberances of the one are in a specific position with regard to the protuberances of the other. In the example shown, the arrangement can be of the “nested” type, so that in the nip between the rollers the protuberances of the one roller are level with the depressions between the protuberances of the other roller. In other embossers, the protuberances of the two rollers are arranged so that in the nip between the rollers at least some of the protuberances of one roller correspond with protuberances of the other and the two plies are laminated in the nip by pressure between the embossing rollers. In this case the laminating roller 111 is not provided and the embosser is of the “tip-to-tip” type. There are also embossing units, which can take both configurations (nested and tip-to-tip).

These types of embossers (also called embosser-laminator, for its double function of embossing and laminating two plies together) is per se known. Examples of embossers are described in WO-A-2004/00727; EP-A-0980751; EP-A-0370972; EP-A-0265298; FR-A-2684598; U.S. Pat. No. 6,053,232.

In the configuration in FIG. 6, which shows nested embossing, a first ply V1 is fed around a counter-roller 105, embossed between this roller and the embossing roller 101 and then glue is applied by the dispenser 109 at protuberances of the embossing roller 101. A second ply V2 is fed about the counter-roller 107, embossed in the nip between this roller and the embossing roller 103 and then transferred to the periphery of the embossing roller 101 to be laminated with the ply V1 against the protuberances of the roller 101 by the laminating roller 111.

The embossing rollers 101 and 103 are each composed of an interchangeable sleeve supported by a pair of expansible centers or heads analogous to those shown in the previous figures and described herein.

As one of the most complex operations, which must be performed in embossing laminating devices, is the correct reciprocal phasing of the embossing rollers, in the example in FIG. 6 advantageously the sleeves of the embossing rollers 101 and 103 are not interchangeable separately from each other, as this would entail subsequent precision adjustment. Instead, pairs of interchangeable sleeves are supported in a common frame and are handled as a single element. The sleeves are fastened in the frame so that they maintain their reciprocal angular phase during handling. FIG. 6 shows three pairs of interchangeable sleeves. The first pair is in the operating position, and forms the embossing rollers 101, 103 having been engaged by two pairs of expansible centers or heads of the type shown in the previous figures. Positioned above the embossing device is a magazine of pairs of sleeves (containing in the example two pairs of interchangeable sleeves). Each pair of sleeves is already angularly phased and the pairs are moved according to the arrows F1, F2 to replace the pair of sleeves in the operating position. It is thereby possible to have, for example, pairs of sleeves already angularly phased, also with different phasing, both tip-to-tip or nested, which can be inserted between the two pairs of expansible centers or heads without requiring subsequent precision adjustment.

When the centers 15 and the interchangeable sleeves 25 are provided with reciprocal interlocking profiles, for example tongues or keys and respective slots, it is possible to use these tongues and the respective slots to rephase the pair of sleeves placed time by time on the centers. For example, the pair of motorized centers can be provided with slots and the various pairs of sleeves can be provided with tongues intended to cooperate with the slots of the centers. Phase between the centers is maintained in a known way, for example with a gear transmission system. Each pair of sleeves can be precision adjusted by regulating the angular position of the respective tongues, so that once the sleeves are interlocked with the centers, the correct reciprocal angular position is always obtained. In this way, a plurality of pairs of sleeves can be produced and each pair can be precision adjusted by regulating and subsequently fastening the tongues thereon. Once this operation has been performed no subsequent regulation or adjustment is required.

Alternatively, the centers can be produced to be reciprocally phased each time, as a function of the angular position to be taken by the sleeves of the pair of sleeves utilized. This can be performed using an electronic system for reciprocal phasing of the centers, analogous to those already used, for example, to phase printing machines. When motion is transmitted from one center to the other by a pair of helical gears, the reciprocal angular position of the centers can be set each time by axially translating one gear with respect to the other. An electronic system can memorize and restore the various axial positions of the moving gear required to correctly phase the pair of sleeves assembled each time on the centers.

When slot and tongue or similar interlocking systems are not provided, an angular phasing function can be obtained analogously, for example with markers which do not have function of transmitting torque, arranged in a suitable angular position on sleeves and centers.

It is understood that the drawing only shows an exemplification given purely as a practical arrangement of the invention, which can vary in forms and arrangements without however departing from the scope of the concept on which the invention is based. Any reference numerals in the appended claims are provided to facilitate reading of the claims with reference to the description and to the drawing, and do not limit the scope of protection represented by the claims.

1-17. (canceled)

18. An embossing device comprising at least one embossing roller and at least one counter-roller cooperating with said embossing roller, wherein the embossing roller comprises an interchangeable sleeve which can be constrained to two heads that engage said sleeve at two ends of said sleeve.

19. The device as claimed in claim 18, wherein a first head of said two heads is supported idle and a second head of said two heads is motorized.

20. The device as claimed in claim 19, wherein said first head moves axially to engage with the interchangeable sleeve and to disengage from said sleeve.

21. The device as claimed in claim 18, wherein at least one of said two heads includes expansible members to torsionally constrain the interchangeable sleeve.

22. The device as claimed in claim 19, wherein at least one of said first head and said second head includes expansible members to torsionally constrain the interchangeable sleeve.

23. The device as claimed in claim 20, wherein at least one of said first head and said second head includes expansible members to torsionally constrain the interchangeable sleeve.

24. The device as claimed in claim 18, wherein both of said two heads includes expansible members.

25. The device as claimed in claim 21, wherein said expansible members are expansible sectors.

26. The device as claimed in claim 18, wherein said interchangeable sleeve includes hollow end portions inside which the two heads engage, centering surfaces cooperating with centering surfaces complementary thereto, provided on a respective one of said two heads, being associated with said hollow ends.

27. The device as claimed in claim 26, wherein the centering surfaces of the interchangeable sleeve are concave conical surfaces, and cooperate with corresponding convex conical surfaces on the heads.

28. The device as claimed in claim 18, wherein at least one of said two heads comprises shaped profiles for torsional interlocking to the interchangeable sleeve, which has corresponding complementary shaped profiles.

29. The device as claimed in claim 28, wherein said shaped profiles comprise at least one tongue on a corresponding one of the two heads and a corresponding groove on a corresponding end of the interchangeable sleeve, or vice versa.

30. The device as claimed in claim 28, wherein said shaped profiles comprise splined profiles.

31. The device as claimed in claim 18, wherein said counter-roller is a pressure roller with a smooth cylindrical surface.

32. The device as claimed in claim 31, wherein said pressure roller is coated in a yielding material.

33. The device as claimed in claim 18, including a path for movement of the interchangeable sleeve to insert said sleeve into or remove said sleeve from the device, said path being contained within a volume of width of the device.

34. The device as claimed in claim 18, including two of said at least one embossing roller and two of said at least one counter-roller, each embossing roller comprising an interchangeable sleeve and a pair of heads which engage a respective center at a respective end of said sleeve.

35. The device as claimed in claim 34, wherein each said interchangeable sleeve is constrained to another sleeve to be replaced simultaneously and to maintain reciprocal angular positioning of each said sleeve.

36. The device as claimed in claim 35, including a magazine of pairs of interchangeable sleeves arranged above or below the at least one counter-roller.
